(19) United States
(12) Patent Application Publication
(10) Pub. No.: US 2013/0093269 A1
(43) Pub. Date: Apr. 18, 2013

(54) SWITCHED RELUCTANCE MOTOR

(71) Applicant: SAMSUNG ELECTRO-MECHANICS CO., LTD., Gyunggi-do (KR)

(72) Inventors: Byeong Han Kim, Gyunggi-do (KR); Han Kyung Bae, Gyunggi-do (KR); Dong Woohn Kim, Gyunggi-do (KR); Chang Hwan Choi, Gyunggi-do (KR)

(73) Assignee: SAMSUNG ELECTRO-MECHANICS CO., LTD., Gyunggi-do (KR)

(21) Appl. No.: 13/652,596

(22) Filed: Oct. 16, 2012

(30) Foreign Application Priority Data
Oct. 18, 2011 (KR) 10-2011-0106497

(51) Int. Cl. H02K 5/24

(52) U.S. Cl. 310/51

(57) ABSTRACT

Disclosed herein is a switched reluctance motor in which a shaft of the motor and a shaft of a load are aligned with each other so that maximum torques of the motor and the shaft coincide with each other.

### CROSS REFERENCE TO RELATED APPLICATION

This application claims the benefit of Korean Patent Application No. 10-2011-0106497, filed on Oct. 18, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a general switched reluctance motor (SRM), both of a stator and a rotor have salient pole type magnetic structures.

In addition, the stator has concentrated type coils wound therearound, and the rotor is configured only of an iron core without any excitation device (windings, permanent magnets, or the like), such that the competitive cost is excellent. Further, speed changeable switched reluctance motor stably generates the continuous torque with the aid of a converter using power semiconductors and a position sensor and is easily controlled to be appropriate for the performance required in each application.

In the switched reluctance motor, when the number of poles is few, the ripple of a generated torque is increased, such that noise and vibration are increased, and when the number of poles is many, the ripple of the generated torque is reduced; however, the cost is increased due to an increase in the number of driving elements and efficiency is reduced due to the rise of the switching frequency.

In the case of the SRM according to the prior art, since the noise and the vibration are increased when the torque ripple of the load is larger, the expensive multi-pole motor having the low torque ripple is used and the high speed controller is used to control the current, thereby controlling the torque.

### SUMMARY OF THE INVENTION

The present invention has been made in the effort to provide the switched reluctance motor having the small number of poles to improve the startability and reduce noise and vibration when the switched reluctance motor having a large torque ripple is connected to the load having the large torque ripple.

According to the preferred embodiment of the present invention, there is provided the switched reluctance motor in which the shaft of the motor and the shaft of the load are aligned with each other so that maximum torques of the motor and the shaft coincide with each other.

A motor structure such as the shape of the rotor, the shape of the stator, or the like, may be designed so that a difference between the torque of the load and the torque of the motor is close to a constant torque.

### BRIEF DESCRIPTION OF THE DRAWINGS

FIG. 1 is a perspective view showing connection between a switched reluctance motor according to a preferred embodiment of the present invention and a compressor load;

FIG. 2 is a cross-sectional view of the switched reluctance motor according to the preferred embodiment of the present invention;

FIGS. 3 and 4 are, respectively, a longitudinal sectional view of the compressor load according to the preferred embodiment of the present invention and a partially enlarged view of a compressed portion;

FIG. 5 is a graph showing a torque curve according to a shaft angle of the compressor load according to the preferred embodiment of the present invention;

FIG. 6 is a graph showing a typical inductance profile of the switched reluctance motor according to the preferred embodiment of the present invention with respect to a single phase; and

FIG. 7 is a graph showing a torque generated when a constant excitation current flows together with the typical inductance profile of the switched reluctance motor according to the preferred embodiment of the present invention with respect to the single phase shown FIG. 6.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

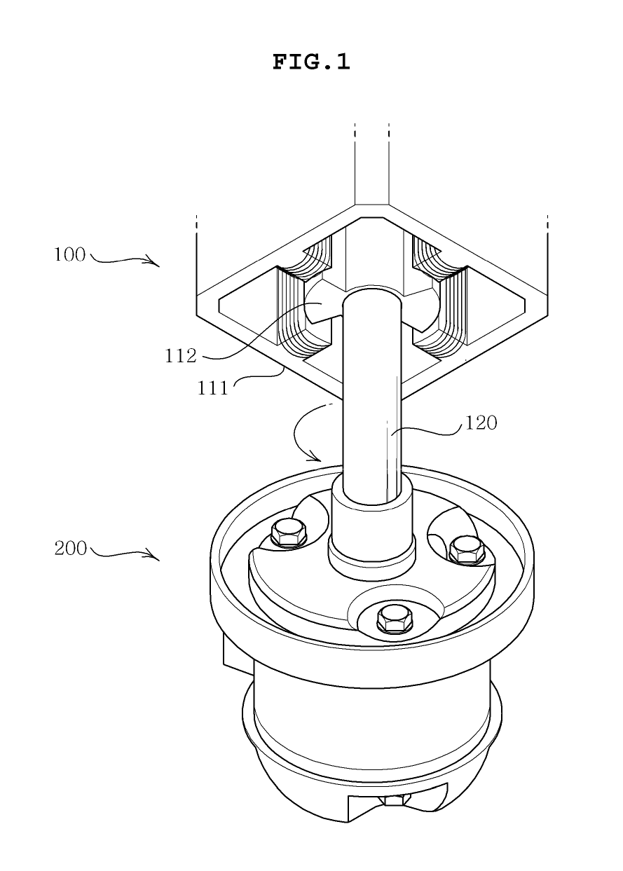

FIG. 1, which is a perspective view showing connection between a switched reluctance motor 100 according to a preferred embodiment of the present invention and a compressor load 200, is a perspective view showing a structure in which a shaft is adjusted so that a torque curve according to an angle of the motor coincides with a torque of the load in the switched reluctance motor.

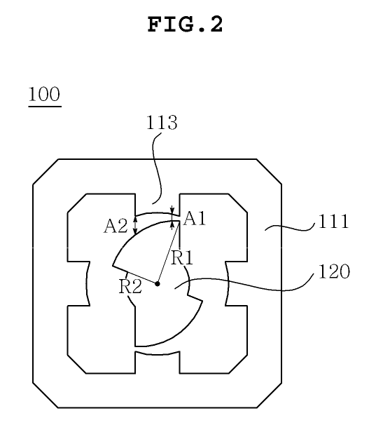

FIG. 2, which is a cross-sectional view of the switched reluctance motor according to the preferred embodiment of the present invention, is a perspective view showing a structure in which a motor structure such as a shape of a rotor, a shape of a stator, or the like, is changed to allow a torque curve of the motor to be similar to that of the load, that is, allow a difference between the torque curve of the motor and the torque curve of the load to be constant.

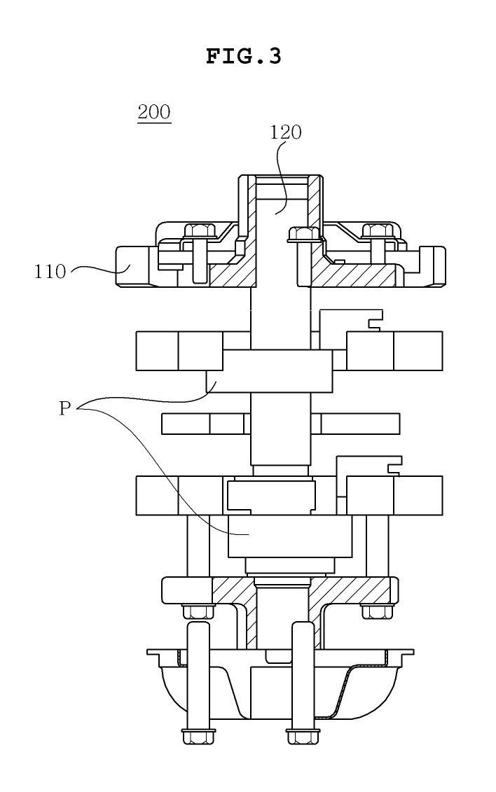

FIGS. 3 and 4 are, respectively, a longitudinal sectional view of the compressor load 200 according to the preferred embodiment of the present invention and a partially enlarged view of a compressed portion.

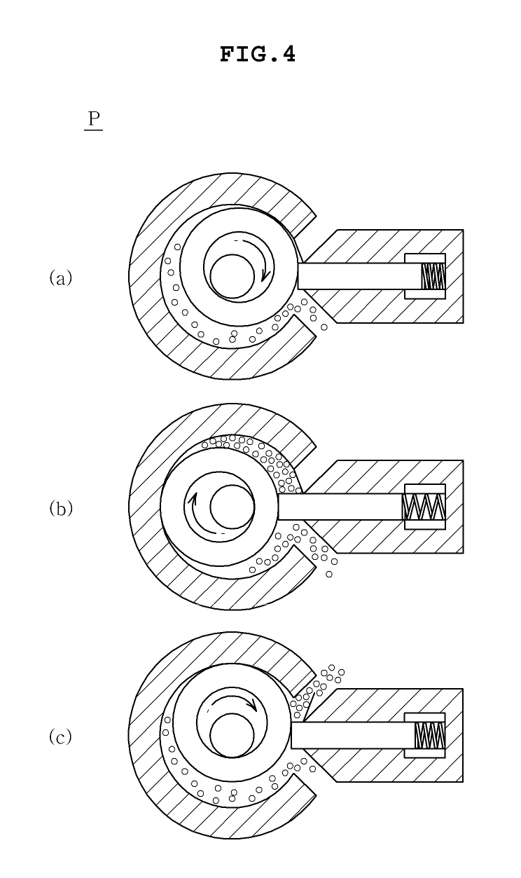

FIG. 5 is a graph showing a torque curve according to a shaft angle of the compressor load 200 according to the preferred embodiment of the present invention.

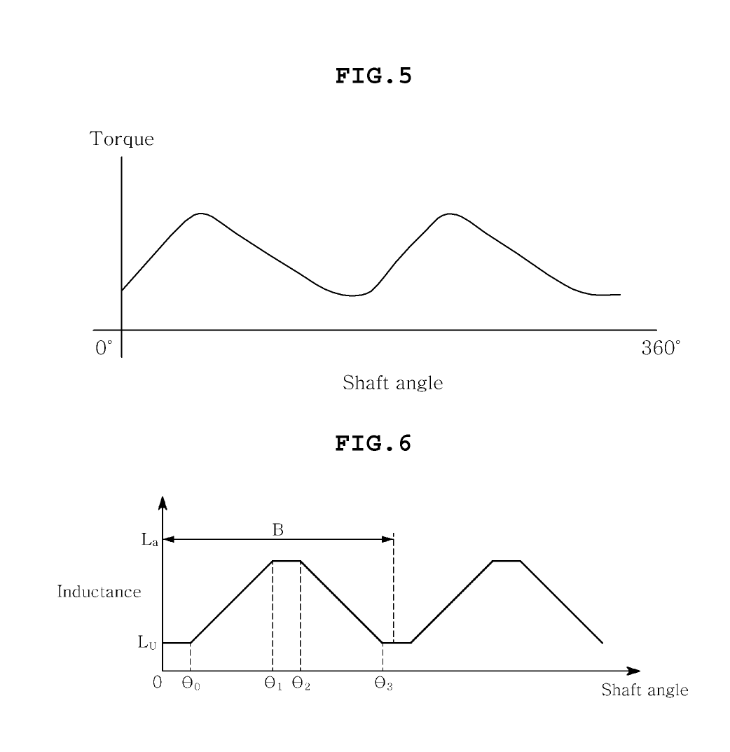

FIG. 6 is a graph showing a typical inductance profile of the switched reluctance motor 100 according to the preferred embodiment of the present invention with respect to a single phase.

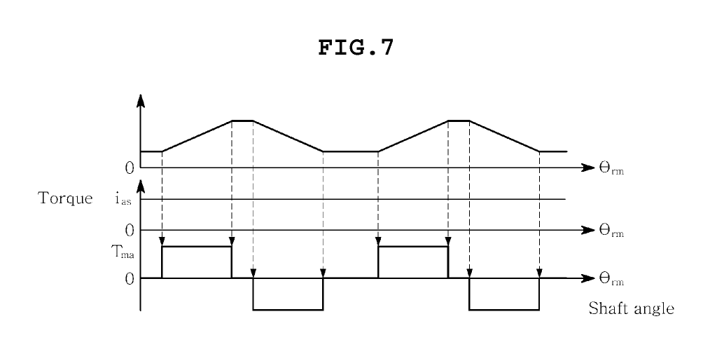

FIG. 7 is a graph showing a torque generated when a constant excitation current flows together with the typical inductance profile of the switched reluctance motor 100 according to the preferred embodiment of the present invention with respect to the single phase shown FIG. 6.

As shown in FIG. 1, the switched reluctance motor 100 according to the preferred embodiment of the present invention is configured to include a stator 111 provided at an edge thereof and a rotor 112 provided at the center of the stator 111 and rotating around a shaft.

An object of the switched reluctance motor 100 according to the preferred embodiment of the present invention is to reduce generation of a torque ripple and secure a minimum value of a starting torque by allowing a difference between a torque of the motor and a torque of the load to be maintained as constant as possible with respect to the entire rotation angle, which is accomplished by aligning a shaft of the motor with a shaft of the load and changing a shape of the motor.

That is, as shown in FIGS. 1 and 2, when a pole of the rotor 112 of the switched reluctance motor 100 according to the preferred embodiment of the present invention faces a pole 113 of the stator 111, one side of the pole of the rotor 112 has a radius R1 larger than a radius R2 of the other side thereof, such that an interval between the pole 113 of the rotor 110 and the stator 112 becomes different according to positions at which the stator 110 and the rotor 112 face each other.

When it is assumed that an interval between an end portion of one side of the rotor 112 and the pole 113 is A1 and an interval between an end portion of the other side thereof and the pole 113 is A2, a length of A is generally smaller than that of A2 (A1<A2).

Reference numeral 100 of FIG. 1 indicates the switched reluctance motor, and reference numeral 200 of FIG. 1 indicates the compressor load. As a result, FIG. 1 is a perspective view showing that the switched reluctance motor and the compressor are connected to each other through a shaft 120.

In the case in which a torque of the load is periodically generated according to a shaft angle, the shaft of the motor is aligned with and connected to the shaft of the load so that maximum values of the torques of the motor and the load coincide with each other.

In this configuration, a torque curve of the motor and a torque curve of the load coincide with each other to allow a torque according to a difference therebetween to be constant, such that angular acceleration becomes constant.

This angular acceleration serves to constantly rotate the shaft by friction at the time of rotation and prevents a ripple.

As described above, according to the present invention, a motor structure such as shapes of the stator 111 and the rotor 112, or the like, is changed to allow the torque curves to coincide with each other.

The torque curves coincide with each other through the change of the motor structure as described above, thereby making it possible to significantly reduce noise and vibration at the time of driving of the switched reluctance motor. The alignment of the shaft of the motor is to adjust a phase difference, and the change of the motor structure is to adjust a peak.

The radii R1 and R2 are changed according to characteristics of the switched reluctance motor, and the load and a reluctance of the switched reluctance motor are affected and a magnetic flux is changed, by whether the intervals A1 and A2 between the rotor 112 and the pole 113 are large or small.

In the case in which a torque ripple of the load is periodically generated according to a shaft angle, a torque ripple of the switched reluctance motor is also periodically generated according to the shaft angle. Therefore, when alignment is performed so that a maximum torque of the load and a maximum torque of the motor coincide with each other, a starting property may be improved and noise and vibration may be reduced.

FIG. 3 is a side view of the compressor load 200 according to the preferred embodiment of the present invention shown in FIG. 1.

As shown in FIGS. 3 and 4, the compressor load 200 includes two cylinders, rotates a shaft, and compresses gas present in a space therebetween while rotating the shaft provided at the center of the cylinders. In this configuration, when the shaft rotates, a compression rate becomes different according to a rotational angle, such that a torque of the load becomes different according to the rotational angle.

A difference between the torque of the motor and the torque of the load according to the rotation of the shaft is generated, which becomes a torque contributing a speed of the motor. Therefore, the speed of the motor is affected by the torque of the motor and the torque of the load.

FIG. 5 is a graph showing a torque change according to a shaft angle of the compressor load 200 according to the preferred embodiment of the present invention shown in FIG. 1, for example, a graph showing a case in which a torque of a twin rotary compressor load is periodically generated according to the shaft angle.

The motor forms a torque curve while compressing gas in the cylinder according to the rotation of the shaft. This torque curve is changed according to a shape of the motor.

The load torque indicates force applied to the shaft. As the shaft rotates, the gas in the cylinder is compressed, and a compression rate is changed according to a rotational angle.

Here, since the compression of the gas according to the rotation of the shaft is not constant, the change in a torque according to the shaft angle is generated as shown in FIG. 5.

FIG. 6 is a graph showing a typical inductance profile of the switched reluctance motor 100 according to the preferred embodiment of the present invention with respect to a single phase, wherein a period in which inductance is increased, a period in which the inductance is reduced, and a period in which the inductance is constant are present according to a positional angle of the rotor 112.

A torque for a single phase is in proportion to a gradient of the inductance according to the positional angle of the rotor as represented by Equation 1.

$$T ( θ , i ) = \frac{1}{2} {i}^{2} \frac{d L ( θ )}{d θ} \qquad [ Equation 1 ]$$

[T: Torque, θ: Positional angle of Rotor, i: Phase Current, L: Inductance]

As shown in FIG. 6, the inductance is maintained as Lu until the shaft angle reaches θ0, is increased from θ0 to θ1, is constant from θ1 to θ2, and is gradually reduced from θ2 to θ3.

A period B of FIG. 6 corresponds to a pole pitch of the rotor. This period is repeatedly formed.

FIG. 7 shows a torque generated when a constant excitation current flows together with the typical inductance profile of the switched reluctance motor 100 according to the preferred embodiment of the present invention with respect to the single phase shown FIG. 6.

In FIG. 7, a positive torque is generated by allowing current to flow only in a period in which the positive torque appears and allowing current to flow in another phase in a period in which a negative torque appears.

In the case of the torque of the load of FIG. 5, since two torque peak values are present at an angle of 360 degrees, when a torque in one phase is increased and a torque in another phase is reduced, the peak values are synchronized with each other in a torque graph.

The switched reluctance motor 100 according to the preferred embodiment of the present invention having the above-mentioned structure and the compressor load 200 are connected to each other to allow the torque curves of the motor and the load to coincide with each other, such that a torque according to a difference therebetween becomes constant, thereby allowing angular acceleration to become constant.

This angular acceleration serves to constantly rotate the shaft by friction at the time of rotation and prevents the ripple.

The torque according to the position of the rotor may be changed according to the gradient of the inductance according to the position of the rotor, and the gradient of the inductance may be controlled by changing an electromagnetic structure of the switched reluctance motor.

Therefore, the motor structure such as the shape of the rotor, the shape of the stator, or the like, is designed so that the difference between the torque of the load and the torque of the motor is close to a constant torque. This structure is provided, thereby making it possible to improve a starting property of the motor and reduce noise and vibration, at the time of driving of the motor. In addition, the motor having a small number of poles is applied to the load having a large ripple, thereby making it possible to reduce a cost.

The switched reluctance motor according to the preferred embodiment of the present invention and the compressor load are connected to each other to allow the torque curve of the motor and the torque curve of the load (compression and friction) to coincide with each other as much as possible, thereby making it possible to allow a torque generated due to a difference therebetween to become constant.

When the torque difference is larger than 0, that is, at the time of a speed increase, the shaft is constantly accelerated to have a constant angular acceleration, thereby making it possible to prevent generation of noise and vibration due to the ripple of the angular acceleration.

When the torque difference is 0, that is, when the torque of the motor and the torque of the load are stable and the speed is thus stabilized, a current speed is maintained, such that a speed ripple is not generated.

In addition, the torque according to the position of the rotor may be changed according to the gradient of the inductance according to the position of the rotor, and the gradient of the inductance may be controlled by changing an electromagnetic structure of the switched reluctance motor.

Therefore, the motor structure such as the shape of the rotor, the shape of the stator, or the like, is designed so that the difference between the torque of the load and the torque of the motor is close to a constant torque.

The above-mentioned structure is provided, thereby making it possible to improve a startability of the motor and reduce noise and vibration, at the time of driving of the motor.

As a result, the motor having a small number of poles is applied to the load having a large ripple, thereby making it possible to reduce a cost.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A switched reluctance motor in which a shaft of the motor and a shaft of a load are aligned with each other so that maximum torques of the motor and the shaft coincide with each other.

2. The switched reluctance motor as set forth in claim 1, wherein a motor structure such as a shape of a rotor, a shape of a stator, or the like, is designed so that a difference between a torque of the load and a torque of the motor is close to a constant torque.
